(19) United States
(12) Patent Application Publication
(10) Pub. No.: US 2011/0000121 A1
(43) Pub. Date: Jan. 6, 2011

(54) Vision system

(76) Inventor: Thomas N. Uhl, Trenton, OH (US)

Correspondence Address: TAFT, STETTINIUS & HOLLISTER LLP, SUITE 1800, 425 WALNUT STREET, CINCINNATI, OH, 45202-3957, US

(21) Appl. No.: 11/818,214

(22) Filed: Jun. 13, 2007

(51) Int. Cl. F41C 27/00; G02B 7/182; F41G 1/34; G02B 7/198

(52) U.S. Cl. 42/90; 359/850; 33/263; 359/865

(57) ABSTRACT

A visual aid comprising: (a) a frame having a fastener allowing selective coupling of the frame to a barrel of a firearm, the frame having a trigger end, a barrel end opposing the trigger end and first and second opposed lateral ends, the frame having coordinate system comprising, (i) a longitudinal axis running through the trigger and barrel ends of the frame, the longitudinal axis having a positive direction from an origin on the frame towards the barrel end and a negative direction from the origin on the frame towards the trigger end, (ii) a lateral axis running through the first and second opposed lateral ends and perpendicular to the longitudinal axis, the lateral axis having a positive direction from the origin on the frame towards the first lateral end and a negative direction from the origin on the frame towards the second lateral end, and (iii) a vertical axis perpendicular to the longitudinal and lateral axes, the vertical axis having a positive direction above the frame and a negative direction below the frame; (b) a first mirror mounted to the frame and facing in a direction having a negative longitudinal component and a positive lateral component and having an angle with respect to both the longitudinal and lateral axes; and (c) a second mirror mounted to the frame and facing in a direction having a negative longitudinal component and a negative lateral component, and having an angle with respect to both the longitudinal and lateral axes, where the first and second mirrors provide two substantially lateral lines of sight to a viewer positioned distal from the trigger end of the frame and parallel to the longitudinal axis.

### FIELD OF THE INVENTION

The present invention is directed to providing multiple reflected lines of sight near the end of a rod or a barrel (such as a gun barrel) and, more specifically, to providing multiple reflected lines of sight using a compact, portable device.

### INTRODUCTION TO THE INVENTION

The present invention is directed to providing multiple reflected lines of sight near or at the end of a rod or a barrel (such as a gun barrel) and, more specifically, to providing multiple reflected lines of sight using a compact, portable device. In exemplary form, the present invention includes a vision system having multiple mirrors oriented to provide lines of sight not otherwise available without changing a line of sight between a gun user and the end of a gun barrel. By using the vision system of the present invention, the gun user is able to have a reflected line of sight around corners in at least two directions, as well as having a reflected line of sight directly above the gun barrel.

The present invention includes a mounting fixture designed to be mounted and/or adapted onto a rifle, shotgun, pistol, or any other type of hand held or machine driven weaponry (or any type of elongated rod, stick or pole) that provides reflected optical axes allowing a user to see objects not otherwise viewable along a single optical axis.

It is a first aspect of the present invention to provide a visual aid comprising: (a) a frame having a fastener allowing selective coupling of the frame to a barrel of a firearm, the frame having a trigger end, a barrel end opposing the trigger end and first and second opposed lateral ends, the frame having coordinate system comprising, (i) a longitudinal axis running through the trigger and barrel ends of the frame, the longitudinal axis having a positive direction from an origin on the frame towards the barrel end and a negative direction from the origin on the frame towards the trigger end, (ii) a lateral axis running through the first and second opposed lateral ends and perpendicular to the longitudinal axis, the lateral axis having a positive direction from the origin on the frame towards the first lateral end and a negative direction from the origin on the frame towards the second lateral end, and (iii) a vertical axis perpendicular to the longitudinal and lateral axes, the vertical axis having a positive direction above the frame and a negative direction below the frame; (b) a first mirror mounted to the frame and facing in a direction having a negative longitudinal component and a positive lateral component and having an angle with respect to both the longitudinal and lateral axes; and (c) a second mirror mounted to the frame and facing in a direction having a negative longitudinal component and a negative lateral component, and having an angle with respect to both the longitudinal and lateral axes, where the first and second mirrors provide two substantially lateral lines of sight to a viewer positioned distal from the trigger end of the frame and parallel to the longitudinal axis.

In a more detailed embodiment of the first aspect, the invention further comprises a third mirror mounted to the frame and facing in a direction having a negative longitudinal component and a positive vertical component and angled with respect to both the longitudinal and vertical axes, where the third mirror provides a third substantially vertical line of sight to the viewer positioned distal from the trigger end of the frame and parallel to the longitudinal axis. In yet another more detailed embodiment, the angle of the third mirror is between 5 and 85 degrees with respect to the longitudinal axis and between 5 and 85 degrees with respect to the vertical axis. In a further detailed embodiment, the angle of the third mirror is between 25 and 65 degrees with respect to the longitudinal axis and between 25 and 65 degrees with respect to the vertical axis. In still a further detailed embodiment, the angle of the first mirror is between 5 and 85 degrees with respect to the longitudinal axis and between 5 and 85 degrees with respect to the lateral axis. In a more detailed embodiment, the angle of the first mirror is between 25 and 65 degrees with respect to the longitudinal axis and between 25 and 65 degrees with respect to the lateral axis. In a more detailed embodiment, the angle of the second mirror is between 5 and 85 degrees with respect to the longitudinal axis and between 5 and 85 degrees with respect to the lateral axis. In another more detailed embodiment, the angle of the second mirror is between 25 and 65 degrees with respect to the longitudinal axis and between 25 and 65 degrees with respect to the lateral axis. In yet another more detailed embodiment, the first mirror is eccentric with respect to the origin. In still another more detailed embodiment, the second mirror is eccentric with respect to the origin.

In yet another more detailed embodiment of the first aspect, the third mirror is eccentric with respect to the origin. In still another more detailed embodiment, the fastener includes a spring clip. In a further detailed embodiment, the invention further comprises at least one of a laser sight and an illumination device. In still a further detailed embodiment, further comprises and adjustable mechanism for changing the angle of at least one of the first mirror and the second mirror. In a more detailed embodiment, the first mirror, the second mirror, and the third mirror lie along different vertical axes. In a more detailed embodiment, the first mirror and the second mirror lie along an auxiliary axis that is parallel to the lateral axis. In another more detailed embodiment, at least two of the first mirror, the second mirror, and the third mirror lie along a different longitudinal axis. In yet another more detailed embodiment, the first mirror and the second mirror are visually distinguishable to the viewer. In yet another more detailed embodiment, the first mirror, the second mirror and the third mirror are visually distinguishable to the viewer.

It is a second aspect of the present invention to provide a vision assembly comprising: (a) a mount comprising at least one of a gun barrel, a pole, and shaft; (b) a frame releasably coupled to the mount, the frame having a near end, a far end opposing the near end and first and second opposed lateral ends, the frame having coordinate system comprising, (i) a longitudinal axis running through the near and far ends of the frame, the longitudinal axis having a positive direction from an origin on the frame towards the far end and a negative direction from the origin on the frame towards the near end, (ii) a lateral axis running through the first and second opposed lateral ends and perpendicular to the longitudinal axis, the lateral axis having a positive direction from the origin on the frame towards the first lateral end and a negative direction from the origin on the frame towards the second lateral end, and (iii) a vertical axis perpendicular to the longitudinal and lateral axes, the vertical axis having a positive direction above the frame and a negative direction below the frame; (c) a first mirror mounted to the frame and facing in a direction having a negative longitudinal component and a positive lateral component and having an angle with respect to both the longitudinal and lateral axes; and (d) a second mirror mounted to the frame and facing in a direction having a negative longitudinal component and a negative lateral component, and having an angle with respect to both the longitudinal and lateral axes, where the first and second mirrors provide two substantially lateral lines of sight to a viewer positioned away from the near end, and farther away from the far end, of the frame and parallel to the longitudinal axis.

It is a third aspect of the present invention to provide a visual aid comprising: (a) a mirror providing a first reflected line of sight having an object side and an image side, the mirror also providing a second reflected line of sight having an object side and an image side, where the second reflected line of sight on the image side intersects the first reflected line of sight on the image side, and where the second reflected line of sight on the object side is opposite the first reflected line of sight on the object side; and (b) a frame mounted to the mirror, the frame including a fastener allowing selective coupling of the mirror to a barrel of a weapon capable of firing a projectile using an explosive charge as a propellant.

### BRIEF DESCRIPTION OF THE DRAWINGS

FIG. 1 is an elevated perspective view from the right front of an exemplary vision system in accordance with the present invention;

FIG. 2 is an elevated perspective view from the left rear of the exemplary vision system of FIG. 1;

FIG. 3 is an bottom perspective view from the right rear of the exemplary vision system of FIG. 1;

FIG. 4 is an bottom perspective view from the left front of the exemplary vision system of FIG. 1;

FIG. 5 is a right side profile view of the exemplary vision system of FIG. 1;

FIG. 6 is an overhead view of the exemplary vision system of FIG. 1;

FIG. 7 is a bottom view of the exemplary vision system of FIG. 1;

FIG. 8 is a front profile view of the exemplary vision system of FIG. 1; and

FIG. 9 is a rear profile view of the exemplary vision system of FIG. 1.

### DETAILED DESCRIPTION OF EXEMPLARY EMBODIMENTS

The exemplary embodiments of the present invention are described and illustrated below to encompass methods of improving vision from a single perspective, as well as devices operative to increase lines of sight and improve vision without subjecting the viewer to a substantially linear projectile path. Of course, it will be apparent to those of ordinary skill in the art that the embodiments discussed below are exemplary in nature and may be reconfigured without departing from the scope and spirit of the present invention. However, for clarity and precision, the exemplary embodiments as discussed below may include optional steps, methods, and features that one of ordinary skill should recognize as not being a requisite to fall within the scope of the present invention.

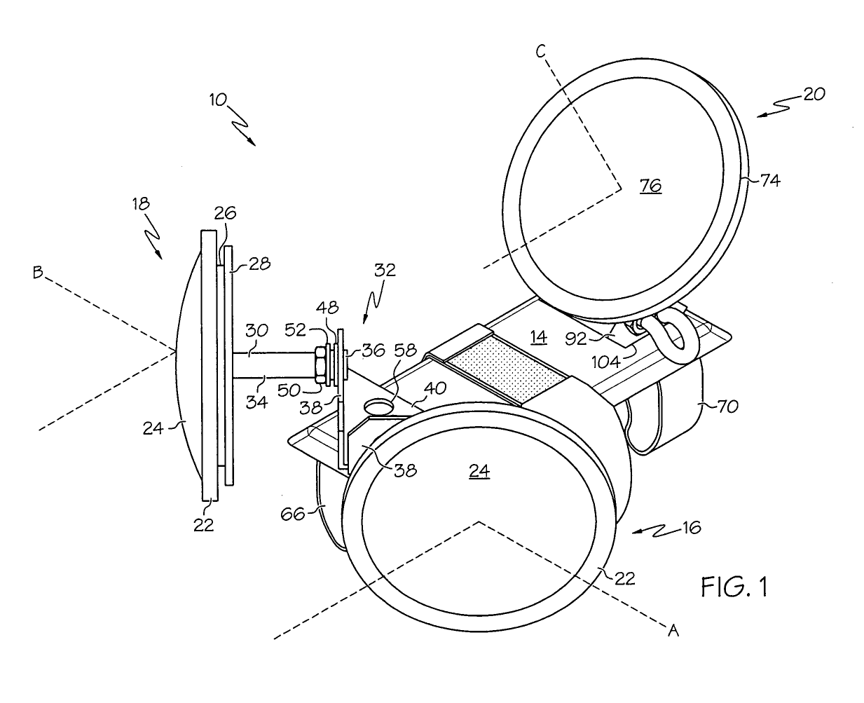

Referencing FIG. 1, an exemplary vision system 10 of the present invention is adapted to be mounted to the end of a gun barrel 12 to provide the gun user with multiple reflected lines of sight. The vision system 10 allows the gun user to maintain his gun sighting and firing position, but also provides multiple, generally perpendicular lines of sight A, B, C (i.e., optical axes) not otherwise obtainable. These lines of sight or optical axes converge or intersect approximate a sighting point of the gun. Generally, this sighting point will be the eye of the user, however, it should be understood that utilization of firearm scopes or other vision systems such as infrared vision systems may operate to change this sighting point. In exemplary form, the vision system 10 allows a gun user to see objects directly to the right and left of the system, as well as directly above the system, while not subjecting the gun user to the substantially linear path of a fired projectile. Thus, the gun user may be shielded from the line of travel of projectiles by using a wall, vehicle, or other object, yet visually inspect his surroundings as if he were not shielded.

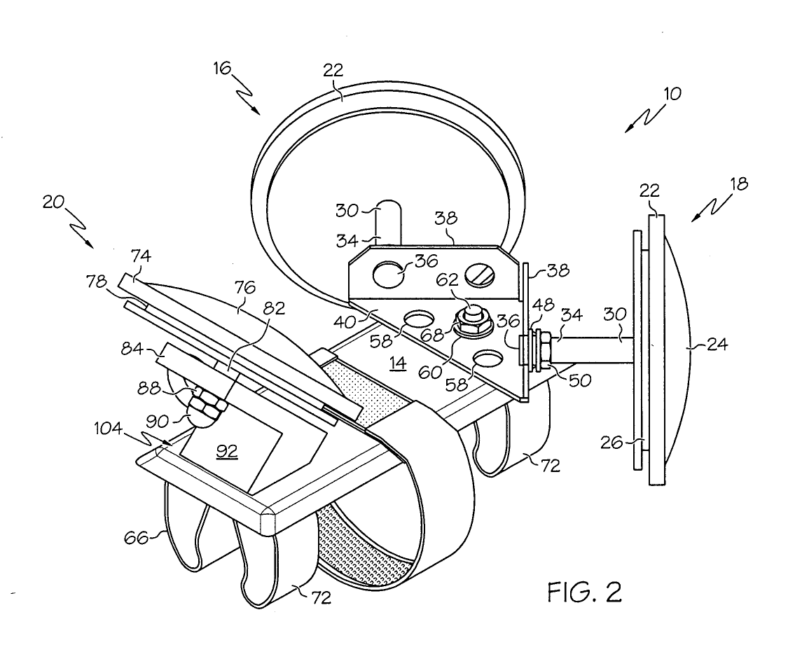

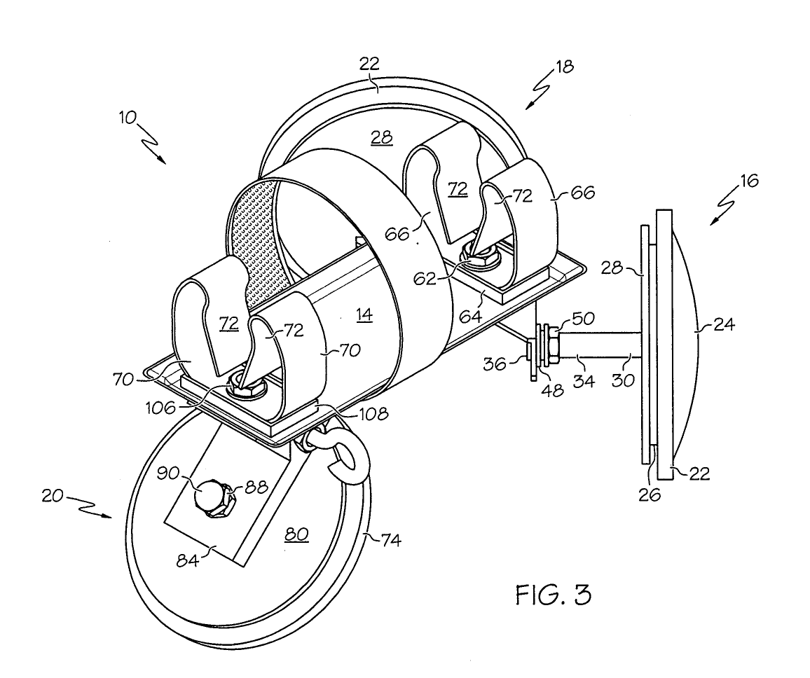

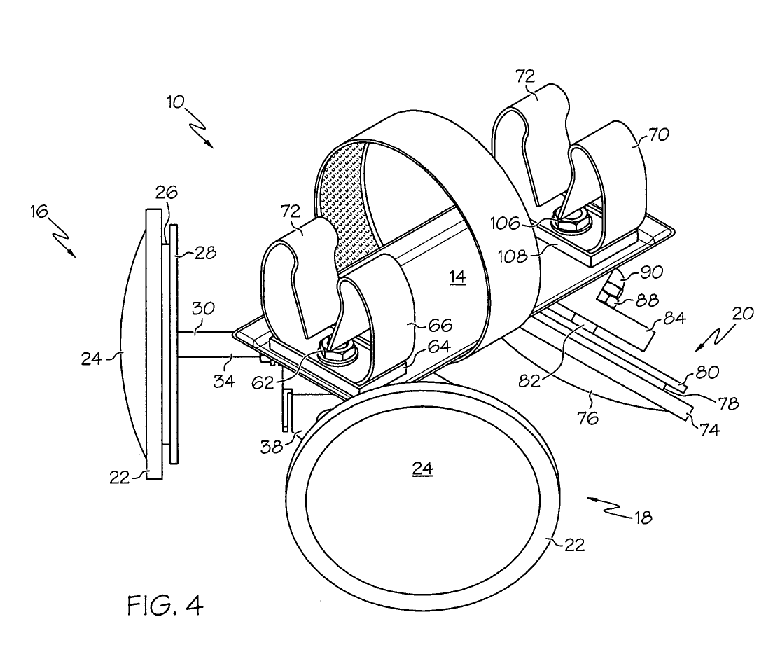

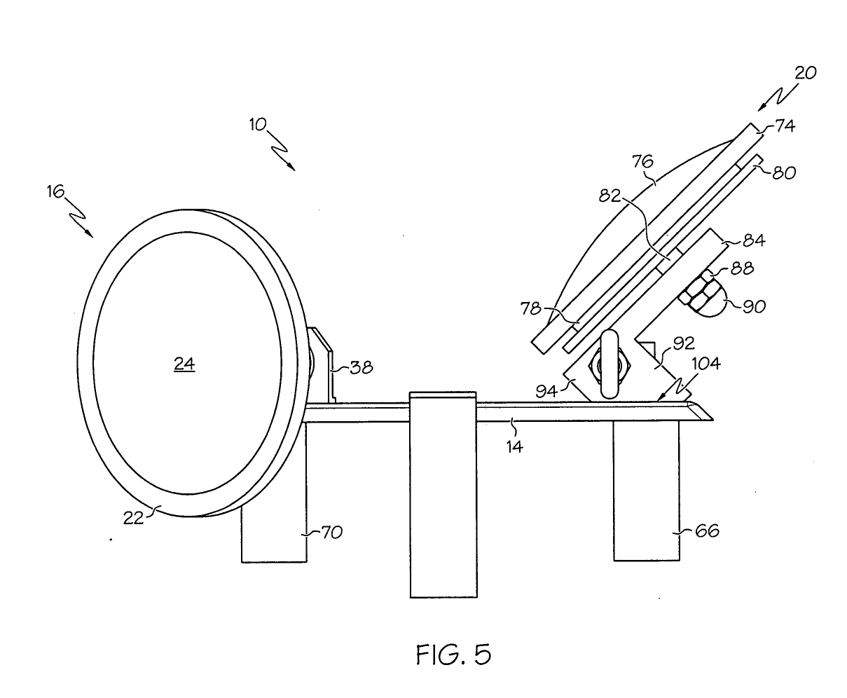

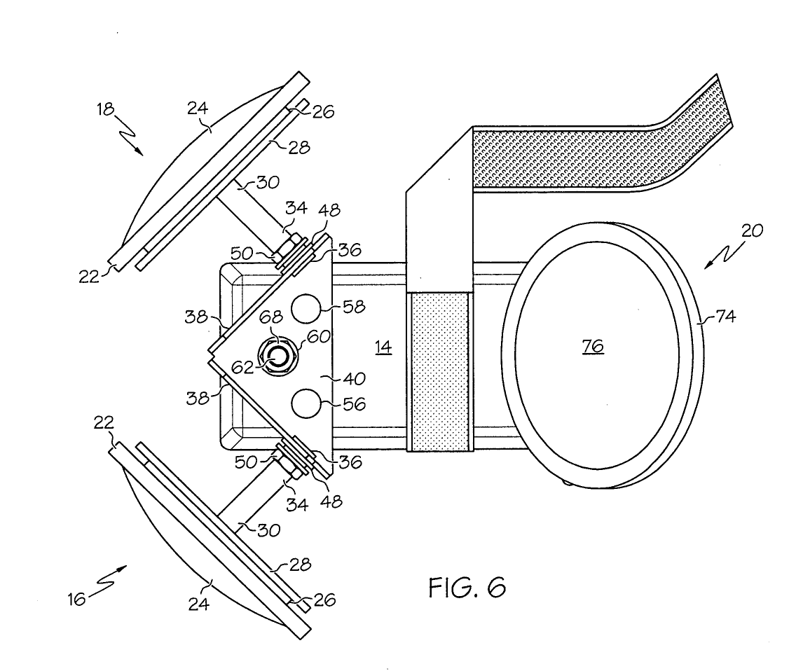

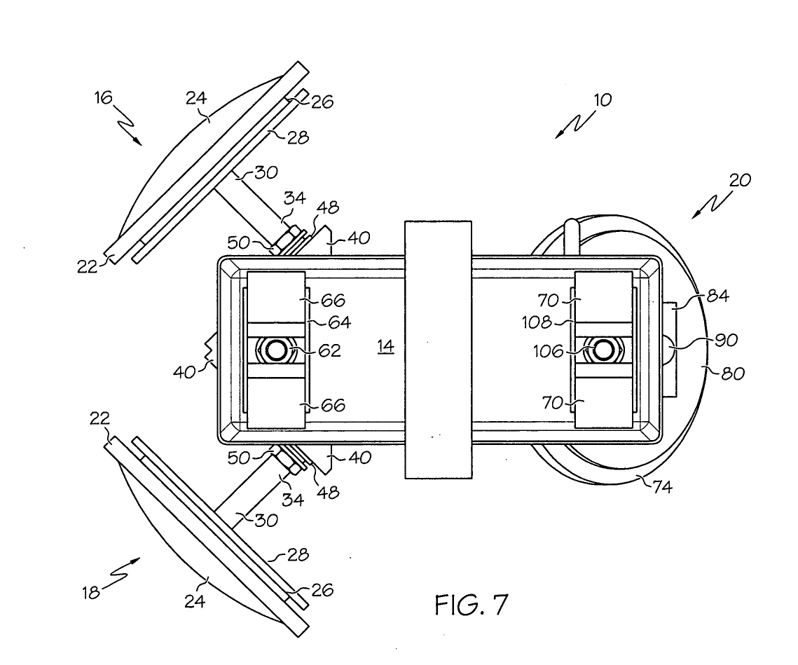

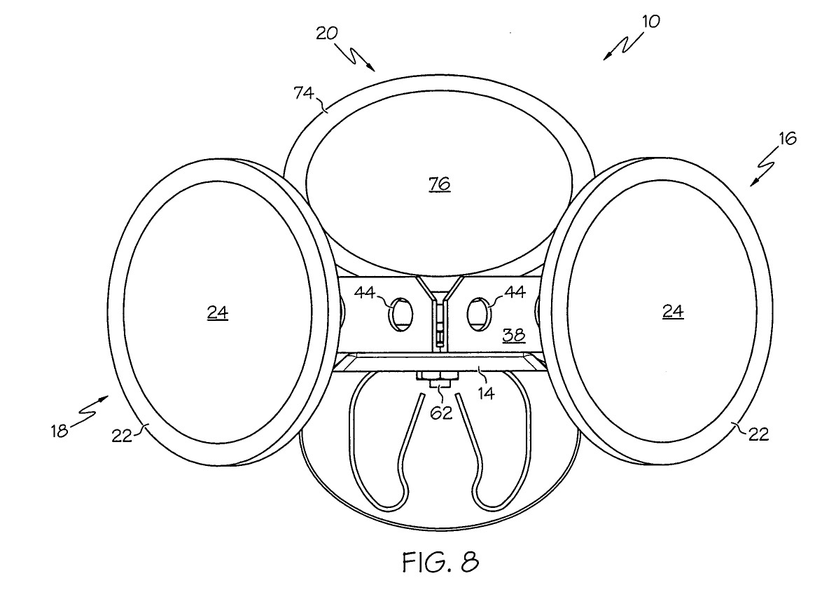

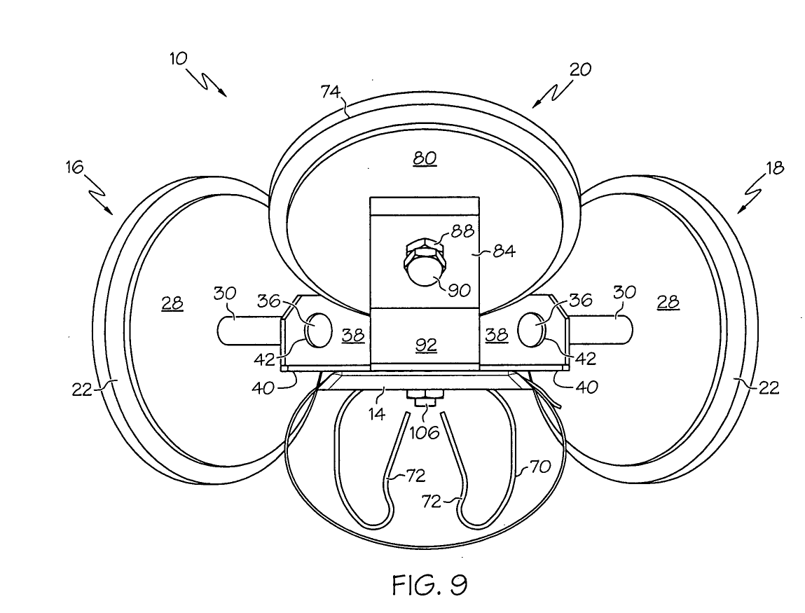

Referring to FIGS. 1-9, the exemplary vision system 10 includes a platform 14 to which three mirror assemblies 16, 18, 20 are mounted to face in differing directions. In exemplary form, the first mirror assembly 16 is oriented along a vertical plane at a +45 degree angle with respect to the longitudinal centerline of the platform 14 and gun barrel 12. This first mirror assembly 16 provides the user with a reflected line of sight A extending perpendicular to the gun barrel 12, thereby allowing the user to view objects to the right of the platform 14. The second mirror assembly 18 is also oriented along the vertical plane at a −45 degree angle with respect to the longitudinal centerline of the platform 14 and gun barrel 12 in order to provide the user with a reflected line of sight B extending perpendicularly from the left side of the platform 14. Finally, the third mirror assembly 20 is backset from the first two mirror assemblies 16, 18 and oriented along a plane that is at a +45 degree angle with respect to the horizontal plane of the top surface of the platform 14. This third mirror assembly 20 provides the user with a reflected line of sight C extending perpendicularly (vertical) above the platform 14. Each reflected line of sight A, B, C includes an object side that is closer to the objects viewed, and an image side that is closer to the eye of the gun user.

Each of the first two mirror assemblies 16, 18 includes a frame 22 that concurrently circumscribes and encloses the periphery and backside of each convex 3″ mirror 24. The frame 22 is comprised of an acrylic and plastic media composite that is shatter resistant, while each mirror 24 provides greater than 90 degrees of panoramic vision as a result of the convex shape. A circular nylon foam bushing 26 with double sided adhesive interposes and mounts the plastic frame 22 to a circular base 28. It is to be understood, however, that any other suitable adhesive material or fastener (such as Velcro, for example), as known to those of ordinary skill in the art, could be used in lieu of adhesive to mount the frame 22 to the base 28. The rear of the circular base 28 includes a cylindrical projection 30 that perpendicularly extends 1.5″ from the base 28 to a mirror support structure 32 mounted to the platform 14. In this exemplary embodiment, the cylindrical projection 30 is hollow and tapped at a proximal end 34 to accept a threaded bolt 36 of the support structure 32.

Each support structure 32 includes two upstanding flaps 38 that extend normal to a triangular base 40. The triangular base 40 is a right triangle, with the upstanding flaps 38 extending from the legs of the triangular base 40. Each flap 38 includes a plurality of mounting holes 42, 44 that can receive the threaded bolt 36, and thus the position the first and second mirror assemblies 16, 18 can be adjusted with respect to one another by simply adjusting which of the mounting holes 42, 44 receives the threaded bolt 36.

In exemplary form, each threaded bolt 36 is mounted to a respective flap 38 by inserting the threaded bolt 36 through one of the mounting holes 42, 44, sliding a washer 48 over the exposed threaded end of the bolt 36 to abut the flap 38. A nut 50 is tightened along the exposed threaded portion (not shown) of the bolt 36 so that continued turning of the nut pulls the end of the bolt 36 against the flap 38 to effectively sandwich the flap 38 and washer 48 between the end of the bolt 36 and the nut 50, to a point at which the nut 50 can no longer be turned. At this point, the threaded bolt 36 is inhibited from rotating with respect to the flap 38, and the tapped cylindrical projection 30 of a mirror assembly 16, 18 may be threaded onto the exposed end of the bolt 36 and tightened to mount the assembly 16, 18 to the support structure 32.

The triangular base 40 is mounted to the platform 14 by a combination of fasteners. Three holes 56, 58, 60 are bored through the base 40, with one of the holes receiving a threaded bolt 62. The first two holes 56, 58 provide overflow outlets for an epoxy resin (not shown) that is sandwiched between the base 40 and platform 14 in order to chemically bond the base 40 to the platform 14. The third hole 60 receives the threaded bolt 62, which has been already circumscribed by a hole (not shown) through the platform 14, a hole (not shown) through a rubber bushing 64, and a hole (not shown) through one of the spring clips 66. A nut 68 is threaded onto the bolt 62 so that tightening of the nut 68 is operative to sandwich the base 40, platform 14, rubber bushing 64, and spring clip 66 between the nut 68 and bolt 62, thereby mounting these elements to the platform 14.

The underside of the platform 14 includes a Velcro strap 65 and a pair of spring clips 66, 70 that deform to mount the vision system 10 to the gun barrel 12. The clips 66, 70 are longitudinally aligned to accept the gun barrel 12 and configured to allow repositionable legs 72 of the clips 66, 70 to expand and collapse evenly around the gun barrel 12. In this manner, the vision system 10 is mounted to the barrel 12 using a compression fit supplied by each leg 72 of the clip 66, 70. The Velcro strap 65 is mounted to the platform 14 at one end and includes opposing loop and pile layers. In this manner, the pile layer circumscribes and contacts the exterior of the barrel 12 so that the looping of the strap 65 engages the free end of the pile layer with the opposed loop layer to secure the strap around the barrel 12. When the system 10 is to be dismounted from the gun barrel 12, the strap 65 is disengaged and the system 10 is simply lifted off of the barrel 12 with sufficient force to spread apart the legs 72 of each clip 66, 70 to allow the cross-section of the barrel 12 to pass therebetween.

Rubber bushings 64, 108 interpose each clip 66, 70 and the underside of the platform 14. The bushings 64, 108 act as dampers to reduce vibration and movement of the gun barrel 12 from being transferred 1:1 to the mirror assemblies 16, 18, 20. Isolation and reduction of vibration is particularly important to enable the user to have a reflected line of sight A, B, C that is not irreparably blurry using one or more of the mirror assemblies 16, 18, 20, nor resulting in damage to the mirror assemblies from recoil when firing the gun.

The third mirror assembly 20 includes a plastic frame 74 that concurrently circumscribes and encloses the periphery and backside of a convex 3″ mirror 76. A circular foam bushing 78 with double sided adhesive interposes and mounts the plastic frame 74 to a circular base 80. It is to be understood, however, that any other suitable adhesive material or fastener (such as Velcro, for example), as known to those of ordinary skill in the art, could be used in lieu of adhesive to mount the frame 74 to the base 80. The rear of the circular base 80 includes a perpendicular threaded bolt (not shown) having a plastic bushing 82 that interposes the backside of the circular base 80 and a top surface of an angled arm 84 of a support bracket 86. A hole (not shown) though the angled arm 84 allows egress of the threaded bolt, which receives two nuts 88, 90 to mount the third mirror assembly 20 to the support bracket 86 and thereby to the platform 14.

The support bracket 86 is machined from a solid metal block to include the angled arm 84 and a base 92 perpendicular to the arm 84. Two cavities 94, 96, one on each side of the bracket 86, are formed by boring out material from the block and subsequently tapping the two cavities. Each of the cavities is amendable to receive additional components such as, without limitation, illumination devices and laser sights such as those available from LaserMax, Industrial Laser and Electronic Engineering, Streamlight, and SureFire.

The base 92 is machined at an end opposite the angled arm 84 to create an angled, flat foundation 104 that abuts the top surface of the platform 14. The angle of the foundation 104 is angled 45 degrees with respect to the base 92 and angled −45 degrees with respect to the horizontal plane, which results in the angled arm 84 and third mirror assembly 20 being angled at +45 degrees with respect to the horizontal plane. A third cavity (not shown) exposed at the bottom of the foundation 104 is tapped to be threaded and receives a threaded bolt 106, which has been already circumscribed by a hole (not shown) through the platform 14, a hole (not shown) through a rubber bushing 108, and a hole (not shown) through the spring clip 70. As the bolt 106 is tightened, it is operative to sandwich the base 40, platform 14, rubber bushing 108, and spring clip 70 between the base 92 and bolt 106, thereby mounting these elements to the platform 14.

All three of the 3″ mirrors 24, 76 are interchangeable with one another so that any mirror 24, 76 and frame 22, 74 can be attached and mounted to any other assembly 16, 18, 20. This is particularly useful when Velcro is utilized to mount the frames 22, 74 to a circular base 28, 80 and render the frames interchangeable.

The exemplary vision system 10 of the present invention can be used in the sportsman industry by sport hunters as an aid to assist with deer, elk, bear, geese, duck and many other game animals. Likewise, the vision system 10 can be used by the toy making industry to be mounted on a wide variety, types, and selection of entertainment guns, such as paint ball guns, water pistols and pellet riffles, as well as many other such similar types of entertainment activity toys. Moreover, the vision system 10 can be adapted to be used as an industrial tool for viewing in hard to see locations when it is mounted onto a fixed or adjustable pole to view hard to see or out of sight locations. Similarly, the vision system 10 can be adapted for use by drainage workers, gas and linemen workers to view down into piping lines, sewer lines and man holes to determine where clogging or constraint conditions may possibly be.

Exemplary end users of the exemplary vision system 10 include, without limitation, civil policing agencies such as policemen and women, sheriffs and deputies, State Troopers, State & Federal Marshals, as well a multitude of other federal and state law enforcement agencies, linemen who have to run electric cables, fiber optic cables as well as many other types of cabling, inspectors of several different types of industries to visually confirm verifications requirements or detect issue and constraints, welders to assure compliance to design specifications and clarity of welds and fits, general contractors and subcontractors in the building industries such as heating and air conditioning workers. The exemplary vision system could also be adapted for use by aircraft and automotive mechanics to confirm and assure proper assemblies and/or fits.

A further exemplary embodiment of the vision system 10 includes a swivel mechanism enabling a user to the tilt or swivel one or more of the three mirror assemblies 16, 18, 20 in order to change the reflected line of sight. This swivel mechanism may be amendable to mounting a targeting laser system such as, without limitation, those available from LaserMax and Industrial Laser and Electronic Engineering. Further, the swivel mechanism may be amendable to mounting a visual light source, including light emitting diode (LEDs) systems to the unit to improve night vision capabilities or dusk lit conditions such as, without limitation, those available from Streamlight and SureFire.

It is also to be understood that the individual mirror assemblies 16, 18, 20 could be exchanged for one or more quadraspherical mirror assemblies, semicircular mirror assemblies, or other shaped mirror assemblies. In exemplary form, a single semicircular or semispherical mirror assembly could be exchanged for the first and second mirror assemblies in order that a single mirror provide reflected lines of sight in opposite perpendicular directions. Moreover, a single quadraspherical mirror assembly may be utilized to replace the first, second, and third mirror assemblies to provide three reflected lines of sight or optical axes that are all generally perpendicular with respect to each other.

Following from the above description and invention summaries, it should be apparent to those of ordinary skill in the art that, while the methods and apparatuses herein described constitute exemplary embodiments of the present invention, the invention contained herein is not limited to this precise embodiment and that changes may be made to such embodiments without departing from the scope of the invention as defined by the claims. Additionally, it is to be understood that the invention is defined by the claims and it is not intended that any limitations or elements describing the exemplary embodiments set forth herein are to be incorporated into the interpretation of any claim element unless such limitation or element is explicitly stated. Likewise, it is to be understood that it is not necessary to meet any or all of the identified advantages or objects of the invention disclosed herein in order to fall within the scope of any claims, since the invention is defined by the claims and since inherent and/or unforeseen advantages of the present invention may exist even though they may not have been explicitly discussed herein.

What is claimed is:

1. A visual aid comprising:
a frame having a fastener allowing selective coupling of the frame to a barrel of a firearm, the frame having a trigger end, a barrel end opposing the trigger end and first and second opposed lateral ends, the frame having coordinate system comprising,
a longitudinal axis running through the trigger and barrel ends of the frame, the longitudinal axis having a positive direction from an origin on the frame towards the barrel end and a negative direction from the origin on the frame towards the trigger end,
a lateral axis running through the first and second opposed lateral ends and perpendicular to the longitudinal axis, the lateral axis having a positive direction from the origin on the frame towards the first lateral end and a negative direction from the origin on the frame towards the second lateral end, and
a vertical axis perpendicular to the longitudinal and lateral axes, the vertical axis having a positive direction above the frame and a negative direction below the frame;
a first mirror mounted to the frame and facing in a direction having a negative longitudinal component and a positive lateral component and having an angle with respect to both the longitudinal and lateral axes; and
a second mirror mounted to the frame and facing in a direction having a negative longitudinal component and a negative lateral component, and having an angle with respect to both the longitudinal and lateral axes;
whereby the first and second mirrors provide two substantially lateral lines of sight to a viewer positioned distal from the trigger end of the frame and parallel to the longitudinal axis.

2. The visual aid of claim 1, further comprising a third mirror mounted to the frame and facing in a direction having a negative longitudinal component and a positive vertical component and angled with respect to both the longitudinal and vertical axes; whereby the third mirror provides a third substantially vertical line of sight to the viewer positioned distal from the trigger end of the frame and parallel to the longitudinal axis.

3. The visual aid of claim 2, wherein the angle of the third mirror is between 5 and 85 degrees with respect to the longitudinal axis and between 5 and 85 degrees with respect to the vertical axis.

4. The visual aid of claim 3, wherein the angle of the third mirror is between 25 and 65 degrees with respect to the longitudinal axis and between 25 and 65 degrees with respect to the vertical axis.

5. The visual aid of claim 1, wherein the angle of the first mirror is between 5 and 85 degrees with respect to the longitudinal axis and between 5 and 85 degrees with respect to the lateral axis.

6. The visual aid of claim 5, wherein the angle of the first mirror is between 25 and 65 degrees with respect to the longitudinal axis and between 25 and 65 degrees with respect to the lateral axis.

7. The visual aid of claim 1, wherein the angle of the second mirror is between 5 and 85 degrees with respect to the longitudinal axis and between 5 and 85 degrees with respect to the lateral axis.

8. The visual aid of claim 7, wherein the angle of the second mirror is between 25 and 65 degrees with respect to the longitudinal axis and between 25 and 65 degrees with respect to the lateral axis.

9. The visual aid of claim 1, wherein the first mirror is eccentric with respect to the origin.

10. The visual aid of claim 1, wherein the second mirror is eccentric with respect to the origin.

11. The visual aid of claim 2, wherein the third mirror is eccentric with respect to the origin.

12. The visual aid of claim 1, wherein the fastener includes a loop and pile fastener.

13. The visual aid of claim 1, further comprising at least one of a laser sight and an illumination device.

14. The visual aid of claim 1, further comprising an adjustable mechanism for changing the angle of at least one of the first mirror and the second mirror.

15. The visual aid of claim 1, wherein the first mirror and the second mirror lie along an auxiliary axis that is parallel to the lateral axis.

16. The visual aid of claim 1, wherein the first mirror, the second mirror, and the third mirror lie along different vertical axes.

17. The visual aid of claim 2, wherein at least two of the first mirror, the second mirror, and the third mirror lie along a different longitudinal axis.

18. The visual aid of claim 1, wherein the first mirror and the second mirror are visually distinguishable to the viewer.

19. The visual aid of claim 2, wherein the first mirror, the second mirror and the third mirror are visually distinguishable to the viewer.

20. A vision assembly comprising:
a mount comprising at least one of a gun barrel, a pole, and shaft;
a frame releasably coupled to the mount, the frame having a near end, a far end opposing the near end and first and second opposed lateral ends, the frame having coordinate system comprising,
a longitudinal axis running through the near and far ends of the frame, the longitudinal axis having a positive direction from an origin on the frame towards the far end and a negative direction from the origin on the frame towards the near end,
a lateral axis running through the first and second opposed lateral ends and perpendicular to the longitudinal axis, the lateral axis having a positive direction from the origin on the frame towards the first lateral end and a negative direction from the origin on the frame towards the second lateral end, and
a vertical axis perpendicular to the longitudinal and lateral axes, the vertical axis having a positive direction above the frame and a negative direction below the frame;
a first mirror mounted to the frame and facing in a direction having a negative longitudinal component and a positive lateral component and having an angle with respect to both the longitudinal and lateral axes; and
a second mirror mounted to the frame and facing in a direction having a negative longitudinal component and a negative lateral component, and having an angle with respect to both the longitudinal and lateral axes;
whereby the first and second mirrors provide two substantially lateral lines of sight to a viewer positioned away from the near end, and farther away from the far end, of the frame and parallel to the longitudinal axis.

21. A visual aid comprising:
a mirror providing a first reflected line of sight having an object side and an image side, the mirror also providing a second reflected line of sight having an object side and an image side, where the second reflected line of sight on the image side intersects the first reflected line of sight on the image side, and where the second reflected line of sight on the object side is opposite the first reflected line of sight on the object side; and
a frame mounted to the mirror, the frame including a fastener allowing selective coupling of the mirror to a barrel of a weapon capable of firing a projectile using an explosive charge as a propellant.
